(19) United States
(12) Patent Application Publication
(10) Pub. No.: US 2005/0046129 A1
(43) Pub. Date: Mar. 3, 2005

(54) Constant center of gravity lift and tilt mechanisms for a wheelchair seat

(76) Inventors: Stephen J. Antonishak, Alden, PA (US); John C. Carminati, Harveys Lake, PA (US); George A. Turturiello, Honesdale, PA (US)

Correspondence Address: Thomas J. Durling;Drinker Biddle & Reath LLP, One Logan Square, 18th and Cherry Streets, Philadelphia, PA, 19103-6996, US

(21) Appl. No.: 10/918,273

(22) Filed: Aug. 13, 2004

Related U.S. Application Data
(60) Provisional application No. 60/495,806, filed on Aug. 15, 2003.

(51) Int. Cl. B62B 9/00

(52) U.S. Cl. 280/47.4

(57) ABSTRACT

A lift mechanism for a wheelchair includes a parallelogram linkage and an actuator for moving the linkage between a retracted position and an extended position to raise and lower a chair. One link of the linkage is slidingly engaged with a rail member. Movement of the linkage is constrained by another link such that as the chair is raised and lowered, the longitudinal position of an occupant's center of gravity relative to the wheelchair frame is substantially maintained. The lift mechanism may be combined with a tilt actuator to allow rotation of the chair. A chair tilt mechanism is also provided having a tilt actuator, a first link slidingly engaged with a rail member and a second link constraining movement of the first link. The tilt mechanism is capable of tilting the chair while substantially maintaining the longitudinal position of the occupant's center of gravity.

### CROSS REFERENCE TO RELATED APPLICATION

This application claims benefit of the filing date of U.S. Provisional Patent Application 60/495,806, “Lift Seats for Wheelchairs,” filed Aug. 15, 2003, the subject matter of which is incorporated herein by reference.

### FIELD OF THE INVENTION

The invention relates to wheelchairs, and especially to mechanisms for raising, lowering and tilting a chair portion of a wheelchair.

### BACKGROUND OF THE INVENTION

It is known to provide a chair portion of a wheelchair with a lifting mechanism to raise and lower the chair. See, for example, European Patent Publication EP 1273282 A2. It is further known to provide a tilting mechanism to tilt the chair forward and aft. For example, U.S. Pat. No. 6,357,776 discloses a wheelchair having a tilt assembly for maintaining the position of a user's center of gravity. It is believed that an invention providing simple and reliable lift and tilt mechanisms capable of substantially maintaining a user's center of gravity in a balanced position over the wheelchair wheels during a lifting or tilting movement would be desirable.

### SUMMARY OF THE INVENTION

In a first aspect, the invention is a wheelchair comprising a frame and a plurality of wheels operatively coupled to the frame for rolling engagement with a supporting surface. A chair includes a backrest and a seat. At least a first seat lifting mechanism is provided, coupled to the seat for raising and lowering the seat. The lifting mechanism includes a rail member coupled to the frame and having a longitudinal axis extending generally parallel to the supporting surface. A non-rotatable first member is slidingly engaged with the rail member. Second and third members are each pivotally coupled at a first end to the first member, and each pivotally coupled at a second end to a fourth member. The first, second, third and fourth members form a closed linkage substantially defining a parallelogram. A fifth member has a first end rotatably coupled to the frame and has a second end rotatably coupled to one of the second and third members at a point intermediate the first and second ends. A lift actuator is operatively attached to at least one of the first through fourth members to control movement of the linkage between a first lift position and a second lift position. In the first lift position the seat is retracted toward the supporting surface and in the second lift position the seat is extended away from the supporting surface. As the lift actuator moves the lift mechanism between the first and second lift positions, the first member slides along the rail member. The fifth member is positioned and dimensioned such that as the linkage moves between the first and second lift positions, the linkage is constrained by the fifth member such that the first member undergoes a displacement along the rail member sufficient to maintain the fourth member in a substantially constant longitudinal position relative to the frame.

Preferably, the wheelchair further comprises a second lift mechanism, and the seat has a right-hand side and a left-hand side. The first lift mechanism is coupled to the right-hand side and the second lift mechanism is coupled to the left-hand side. The lift actuator is preferably a linear actuator, however, a rotary actuator could also be used. Preferably, the linear actuator is rotatably attached at a first end to the first member and rotatably attached at a second end to the fourth member and the linear actuator extends to move the linkage from the first lift position to the second lift position. Preferably, the chair is fixedly coupled to the fourth member. A lift damper may be provided to resist motion of the linkage as the linkage moves between the second lift position and the first lift position. To facilitate movement of the first member relative to the rail member, the first member may include a bearing operatively coupled to the rail member.

In a second aspect, the invention is a wheelchair comprising a frame and a plurality of wheels operatively coupled to the frame for rolling engagement with a supporting surface. The wheelchair further comprises a chair including a backrest and a seat having a forward end and a rearward end, the chair having a first tilt position wherein the seat is substantially parallel with the supporting surface and a second tilt position wherein the seat is tilted relative to the supporting surface such that the forward end is higher relative to the supporting surface than the rearward end. A chair tilting mechanism includes a rail member fixedly coupled to the frame and having a longitudinal axis extending generally parallel to the supporting surface. A first member is fixedly coupled to the seat and has a first end and a second end. The second end is slidingly engaged with the rail member. A second member has a first end rotatably coupled to the frame and a second end rotatably coupled to the first member at a point intermediate the first member first and second ends. A linear tilt actuator has a first end rotatably coupled to the frame and has a second end rotatably coupled to the first end of the first member. The tilt actuator controls movement of the chair between the first tilt position and the second tilt position. The second member is positioned and dimensioned such that as the chair is moved between the first and second tilt positions, the second end of the first member slides along the rail member and a center of gravity of a user occupying the chair is maintained in a substantially constant longitudinal position relative to the frame.

In yet a third aspect, the invention is a wheelchair comprising a frame and a plurality of wheels operatively coupled to the frame for rolling engagement with a supporting surface. The wheelchair further comprises a chair including a backrest and a seat having a first end and a second end. A combined chair lift and tilt mechanism has at least a first chair lifting mechanism coupled to the chair for raising and lowering the chair. The chair lifting mechanism includes a rail member coupled to the frame and having a longitudinal axis extending generally parallel to the supporting surface. A non-rotatable first member is slidingly engaged with the rail member. Second and third members are each pivotally coupled at a first end to the first member, and each pivotally coupled at a second end to a fourth member. The first, second, third and fourth members form a closed linkage substantially defining a parallelogram. The fourth member is rotatably coupled to the seat proximate the seat first end. A fifth member has a first end rotatably coupled to the frame and has a second end rotatably coupled to one of the second and third members at a point intermediate the first and second ends. A lift actuator is operatively attached to at least one of the first through fourth members to control movement of the linkage between a first lift position and a second lift position. In the first lift position the seat is retracted toward the supporting surface and in the second lift position the seat is extended away from the supporting surface. As the lift actuator moves the lift mechanism between the first and second lift positions, the first member slides along the rail member. The fifth member is positioned and dimensioned such that as the linkage moves between the first and second lift positions, the linkage is constrained by the fifth member such that the first member undergoes a displacement along the rail member sufficient to maintain the fourth member in a substantially constant longitudinal position relative to the frame. A tilt actuator is operatively coupled to the seat, wherein the tilt actuator controls movement of the chair between a first tilt position and a second tilt position.

### BRIEF DESCRIPTION OF THE DRAWINGS

For the purpose of illustrating the invention, there are shown in the drawings forms of the invention which are presently preferred; it being understood, however, that this invention is not limited to the precise arrangements and instrumentalities shown. In the drawings:

FIG. 1 is a side view of an otherwise conventional wheelchair incorporating the present invention.

FIG. 2 is a partially schematic side view of a lifting mechanism in accordance with a first preferred embodiment of the present invention, shown in a lowered position and shown coupled to a chair of the wheelchair of FIG. 1.

FIG. 3 is a partially schematic side view of the lifting mechanism of FIG. 2, shown in a raised position.

FIG. 4 is a partially schematic side view of a tilting mechanism in accordance with a second preferred embodiment of the present invention, shown in a non-tilted position and shown coupled to a chair of the wheelchair of FIG. 1.

FIG. 5 is a partially schematic side view of the tilting mechanism of FIG. 4, shown in a tilted position.

FIG. 6 is a partially schematic side view of a first embodiment of a combined chair lift and tilt mechanism, combining the lifting mechanism of FIG. 2 with a tilt actuator and shown in a raised, non-tilted position.

FIG. 7 is a perspective view of a second embodiment of a combined lift and tilt mechanism, shown in a lowered, non-tilted position.

FIG. 8 is a side view of the combined lift and tilt mechanism of FIG. 7.

FIG. 9 is a perspective view of the combined lift and tilt mechanism of FIG. 7, shown in a raised, non-tilted position.

FIG. 10 is a side view of the combined lift and tilt mechanism of FIG. 7, shown in a raised, non-tilted position.

FIG. 11 is a perspective view of the combined lift and tilt mechanism of FIG. 7, shown in a raised, tilted position.

FIG. 12 is a side view of the combined lift and tilt mechanism of FIG. 7, shown in a raised, tilted position.

### DETAILED DESCRIPTION OF THE DRAWINGS

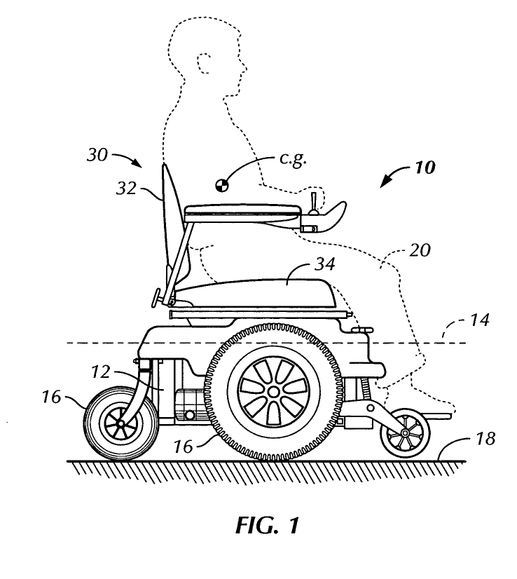

Referring to the drawings, and initially to FIG. 1, an otherwise conventional wheelchair incorporating the present invention is indicated generally by the reference numeral 10. The wheelchair 10 comprises a frame 12 having a longitudinal axis 14. A plurality of wheels 16 are operatively coupled to the frame for rolling engagement with a supporting surface 18. The wheelchair 10 further comprises a chair 30 having a backrest 32 and a seat 34. The chair 30 is adapted to accommodate a user 20. The user 20 has a center of gravity e.g. While a mid-wheel power wheelchair is shown, the present invention could be adapted to be incorporated into virtually any type of conventional powered wheelchair.

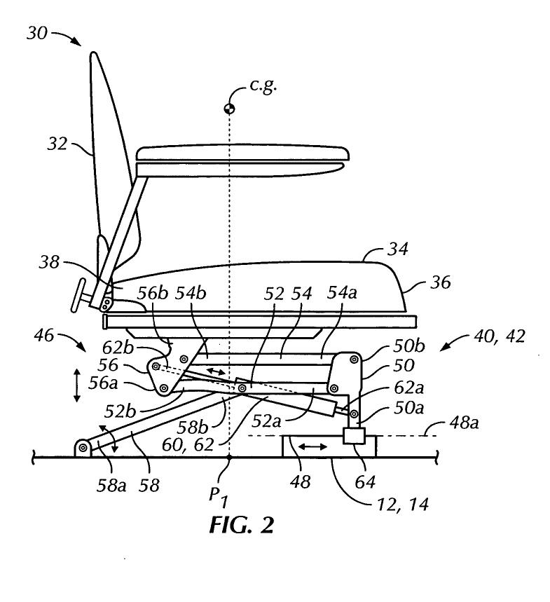

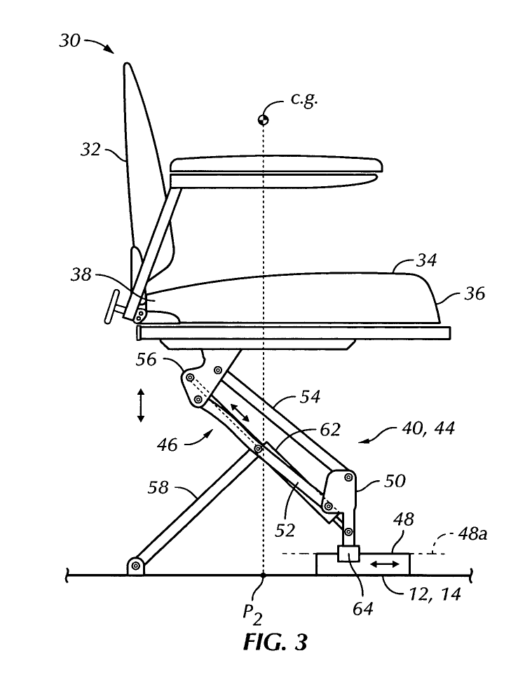

With reference now to FIGS. 2 and 3, a seat lifting mechanism 40 is coupled to the seat 34 for raising and lowering the seat 34. The seat includes a forward end 36 and a rearward end 38. The lifting mechanism 40 is shown in a lowered, first lift position 42 in FIG. 2 and in a raised, second lift position 44 in FIG. 3. The lifting mechanism 40 includes a rail member 48 coupled to the frame 12 and having a longitudinal axis 48A extending generally parallel to the supporting surface 18. A non-rotatable first member 50 is slidingly engaged with the rail member 48. A second member 52 has a first end 52A and a second end 52B, while a third member 54 also has a first end 54A and a second end 54B. Second and third members 52, 54 are each pivotally coupled at their respective first ends 52A, 54A to the first member 50, and each is also pivotally coupled at their respective second ends 52B, 54B to a fourth member 56. The first, second, third and fourth members 50-56 form a closed linkage 46 substantially defining a parallelogram. That is, the connection points where the first through fourth members 50-56 are joined define corners of a parallelogram.

The seat lifting mechanism 40 further comprises a fifth member 58 having a first end 58A rotatably coupled to the frame 12 and having a second end 58B rotatably coupled to one of the second and third members 52, 54 at a point intermediate the first and second ends.

A lift actuator 60 is operatively attached to at least one of the first through fourth members 50-56 to control movement of the linkage 46 between the lowered, first lift position 42 and the raised, second lift position 44. In the first lift position 42 the seat 34 is retracted toward the supporting surface 18 and in the second lift position 44 the seat 34 is extended away from the supporting surface 18. As the lift actuator 60 moves the lift mechanism 40 between the first and second positions 42 and 44, the first member 50 slides along the rail member 48. As the first member 50 is fixed against rotation, the fourth member 56 does not rotate during movement of the linkage 46, but merely translates up and down.

The fifth member 58 is positioned and dimensioned such that as the linkage 46 moves between the first and second lift positions 42 and 44, movement of the linkage 46 is constrained by the fifth member 58 such that the first member 50 undergoes a displacement along the rail member 48 sufficient to maintain the fourth member 56 in a substantially constant longitudinal position relative to the frame 12. That is, in the first position 42, the center of gravity e.g. of the user 20 has a first longitudinal position PI relative to the frame 12 (see FIG. 2), while in the second position 44 the center of gravity e.g. has a second longitudinal position P2 relative to the frame 12 (see FIG. 3). The first and second longitudinal positions P1 and P2 are substantially the same.

Preferably, the wheelchair 10 comprises two lift mechanisms 40: a first lift mechanism 40 coupled to a right-hand side of the seat 34 and a second lift mechanism 40 coupled to a left-hand side of the seat 34. The lift actuator 60 is preferably a linear actuator 62, however, a rotary actuator (not illustrated) could also be used. Preferably, the linear actuator 62 is rotatably coupled at a first end 62A to the first member 50 and rotatably coupled at a second end 62B to the fourth member 56 and the linear actuator 62 extends to move the linkage 46 from the first lift position 42 to the second lift position 44. A lift damper (not illustrated for this embodiment) may be provided to resist motion of the linkage 46 as the linkage 46 moves between the second lift position 44 and the first lift position 42. To facilitate movement of the first member 50 relative to the rail member 48, the first member 50 may include a bearing 64, for example a sleeve bearing or other conventional bearing, operatively coupled to the rail member 48.

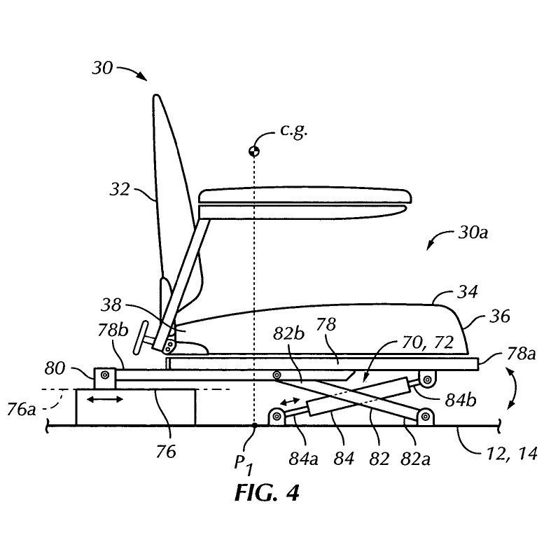

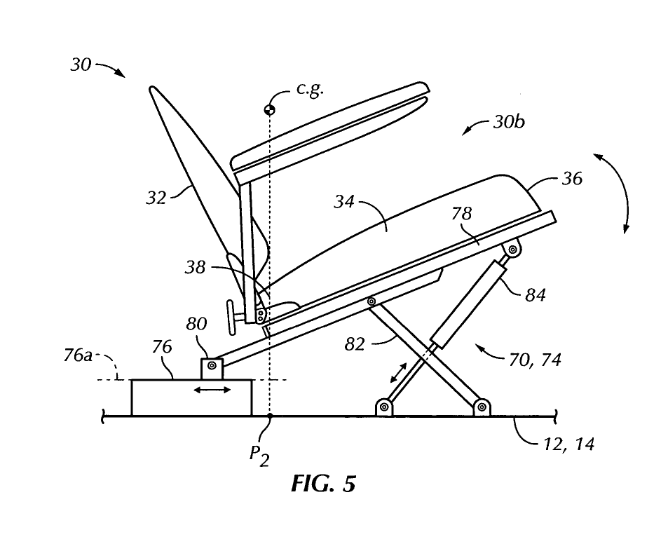

With reference now to FIGS. 4 and 5, in a second preferred embodiment of the invention, the wheelchair 10 comprises a chair tilting mechanism 70. In FIG. 4, the chair tilting mechanism 70 is shown in a first tilt position 72, corresponding to a non-tilted position 30A of the chair 30 wherein the seat 34 is substantially parallel with the supporting surface 18. In FIG. 5, the chair tilting mechanism 70 is shown a second tilt position 74, corresponding to a tilted, second position 30B of the chair 30 wherein the seat 34 is tilted relative to the supporting surface 18 such that the forward end 36 is higher relative to the supporting surface 18 than the rearward end 38.

The tilting mechanism 70 includes a rail member 76 fixedly coupled to the frame 12 and having a longitudinal axis 76A extending generally parallel to the supporting surface 18. A first member 78 is fixedly coupled to the seat 34 and has a first end 78A and a second end 78B. The second end 78B is slidingly engaged with the rail member 76. Preferably, the first member 78 is coupled to rail member 76 by a bearing 80. A second member 82 has a first end 82A rotatably coupled to the frame 12 and a second end 82B rotatably coupled to the first member 78 at a point intermediate the first member first and second ends, 78A and 78B.

A linear tilt actuator 84 has a first end 84A rotatably coupled to the frame 12 and has a second end 84B rotatably coupled to the first member first end 78A. The actuator 84 controls movement of the chair 30 between the first non-tilted position 30A and the second tilted position 30B. The second member 82 is positioned and dimensioned such that as the chair 30 is moved between the first and second positions 30A and 30B, the first member second end 78B slides along the rail member 76 and the center of gravity e.g. of the user 20 occupying the chair 30 is maintained in a substantially constant longitudinal position relative to the frame 12. That is, in the first non-tilted chair position 30A, the center of gravity e.g. of the user 20 has a first longitudinal position P1 relative to the frame 12, while in the second tilted chair position 30B the center of gravity e.g. has a second longitudinal position P2 relative to the frame 12. The first and second longitudinal positions P1 and P2 are substantially the same.

Preferably, the linear tilt actuator 82 extends to move the chair 30 from the first non-tilted position 30A to the second tilted position 30B and conversely retracts to move the chair 30 from the second position 30B to the first position 30A. It is desirable that the linear actuator 82 extend when moving in a direction such that the motion of the tilt actuator 82 is not assisted by gravity, as the linear actuator 82 possesses higher load capacity during an extension stroke than during a retraction stroke.

Also, as with the lift mechanism 40 described herein above, the tilt mechanism 70 preferably further comprises a damper (not illustrated for this embodiment) operatively coupled to the seat 34 to resist motion of the chair 30 as the chair moves between the second tilted position 30B and the first non-tilted position 30A.

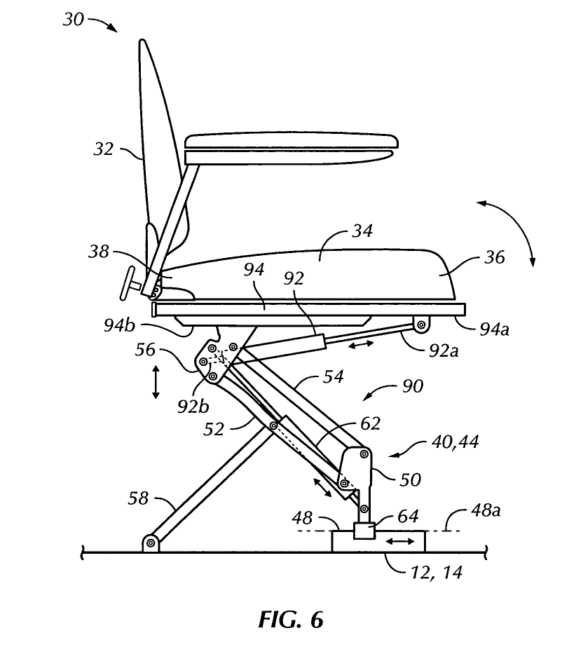

With reference now to FIG. 6, in a third preferred embodiment the wheelchair 10 comprises a combined chair lifting and tilting mechanism 90. The combined chair lifting and tilting mechanism 90 is essentially the lift mechanism 40, wherein the chair 30 is rotatably coupled to the fourth member 56, in combination with a tilt actuator 92. A seat member 94 is provided, having a first end 94A and a second end 94B. The seat member 94 is rotatably coupled to the fourth member 56 proximate the second end 94B, and rotatably coupled to the tilt actuator 92 proximate the first end 94A. Although illustrated to be coupled to the fourth member 56, the second end 92B could be coupled to other members.

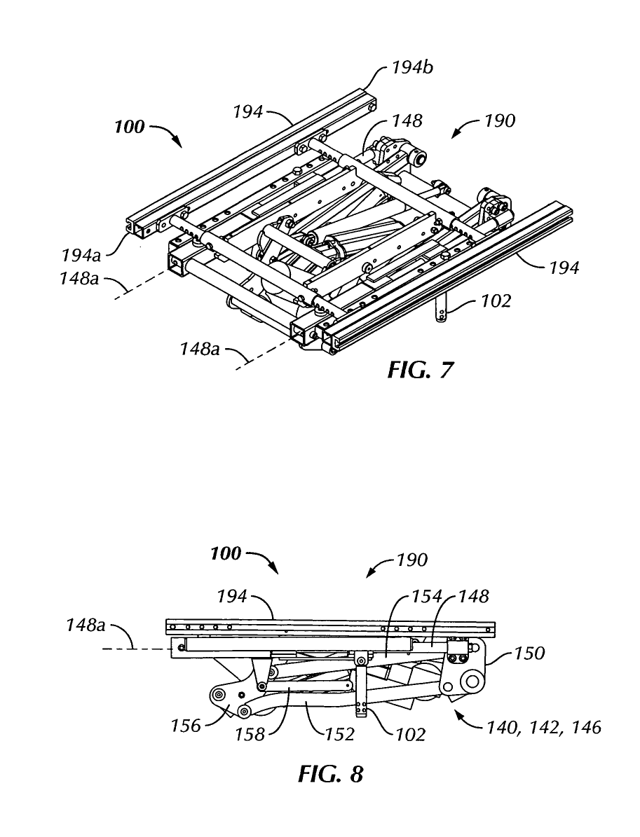

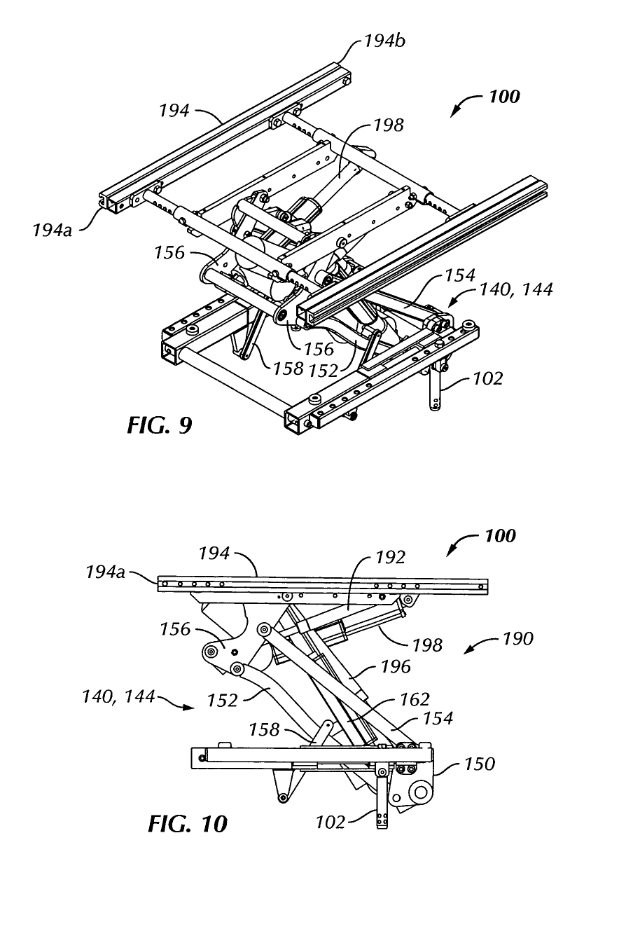

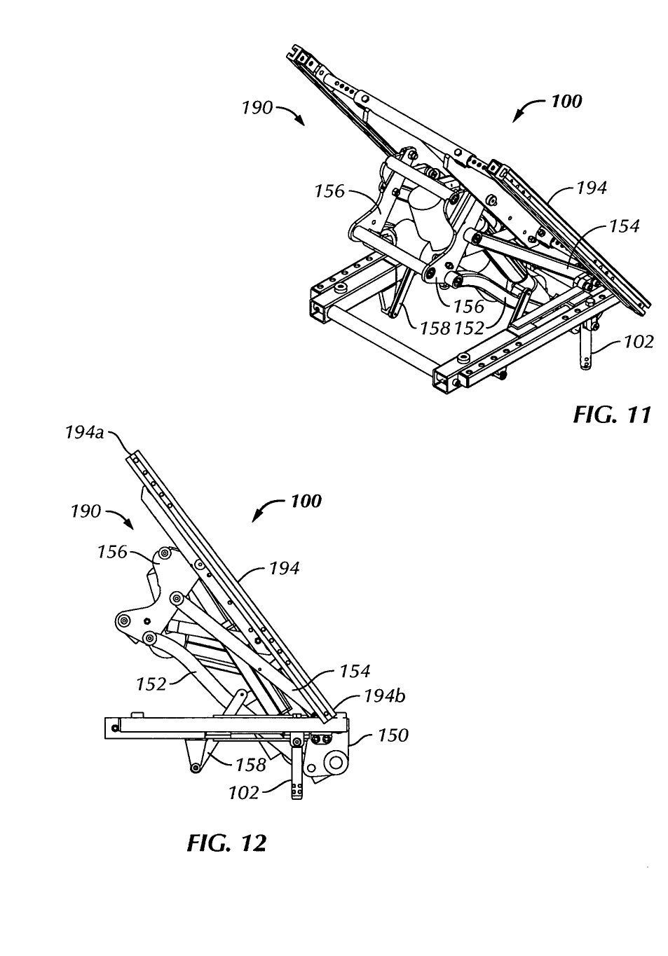

With reference now to FIGS. 7-12, a particular construction of an assembly 100, incorporating a second embodiment 190 of the combined lift and tilt mechanism, is shown in various operational positions. The second embodiment lift and tilt mechanism 190 differs primarily from the first embodiment lift and tilt mechanism 90 illustrated in FIG. 6 in the orientation of the chair 34 relative to the mechanisms 90 and 190, respectively. More particularly, in the first embodiment lift and tilt mechanism 90, the first member 50 is proximate the seat forward end 36; the fourth member 56 is proximate the sear rearward end 38; and during the tilting operation, the tilt actuator 92 extends forward to rotate the seat forward end 36 upwards. In contrast, the second embodiment 190 comprises: a lower plate 150, corresponding to the first member 50 of the first embodiment mechanism 90, positioned proximate a rearward end 194B of seat support members 194; an upper plate 156, corresponding to the fourth member 56, positioned proximate a forward end 194A of the seat support members; and during a tilting movement, a tilt actuator 192 retracts to pull the rearward end of the seat 34 downward. The person of ordinary skill in the art will recognize that the assembly 100 could be modified to incorporate the first embodiment lift and tilt mechanism 90 rather than the second embodiment lift and tilt mechanism 190.

Components of the second embodiment lift and tilt mechanism 190 have been assigned reference numbers incremented by 100 above generally corresponding elements of the first embodiment lift and tilt mechanism 90. For example, the lift mechanism 140 of the second embodiment 190 corresponds generally to the lift mechanism 40 of the first embodiment 90.

The assembly 100 shown in FIGS. 7-12 is designed to permit the assembly 100 to be incorporated into a newly manufactured wheelchair, or to be installed as a retrofit to an existing wheelchair with relatively minimal changes to other parts of the wheelchair. In a retrofit installation, the necessary power and control lines would need to be provided, and a control unit would need to include the necessary additional switches to operate the lift and tilt mechanism 190. Interlocks could be provided within the control unit, for example, to limit the maximum speed of the wheelchair 10 when the lift and tilt mechanism 190 is raised. Any such interlocks may be essentially the same as on previously proposed lift wheelchairs and, in the interests of conciseness, are not further described here.

The assembly 100 comprises a mounting frame, comprising two side rails and a front crossbar. A rear crossbar may also be provided. Each of the side rails has a number of holes, into which may be bolted posts 102 that extend downwards. The posts 102 are received in sockets in a base portion of the wheelchair 10. The posts 102 are provided with a plurality of transverse holes. By putting mounting pins through selected ones of these holes and corresponding holes in the sockets in the base, the height of the mounting frame above the base, and the inclination of the base, may be adjusted. This enables the fore-and-aft tilt of the seat 34 in its non-tilted first position 30A to be adjusted.

As shown in FIGS. 7-12, the posts 102 are provided near an aft end of each side rail. Additional posts 100 may be provided. Several holes are preferably provided in each side rail, to allow the posts 102 to be positioned correctly for mating sockets in any of a wide range of bases.

Each side rail comprises a pair of bearing sleeves, corresponding to the bearings 64 in the first embodiment lift and tilt mechanism 90. Each bearing sleeve receives a shaft 148 that can slide freely along its length, forwards and backwards relative to the wheelchair 10, in the bearing sleeves. The front end of each shaft 148 is enclosed by a shroud forming part of the side rail. Although plain sleeve bearings are preferred, as they are very simple and allow a mounting with very little play, other forms of bearings, for example, including some form of rolling mechanism, may be used if the frictional drag from plain sleeve bearings is found to be inconveniently high.

To the rear end of each shaft 148 is fixed a lower plate 150, corresponding to the first member 50 of FIG. 6. Lower and upper lift arms 152, 154, respectively, corresponding to second and third links 52 and 54, are rotatably connected to the lower plate 150. An upper plate 156, corresponding to fourth member 56, forms a fourth link of a parallelogram linkage 146 and is rotatably connected to the other ends of each lower and upper lift arm 152, 154.

In the second embodiment lift and tilt mechanism 190, the lower lift arms 152 are curved. This curvature does not affect the operation of the lift and tilt mechanism 190. When the lift mechanism 140 is fully lowered into a first lowered position 142, the lift and tilt mechanism 190 is almost entirely below the mounting frame. In order to improve the stability of the wheelchair 10 in normal use, the seat 34 is mounted as low as possible, which requires the fully-lowered lift and tilt mechanism 190 to be positioned as low as possible. As a result, the lift and tilt mechanism 190 encroaches on regions of the base where other equipment may be present. The curvature of the lower lift arms 152 serves to illustrate that, provided the structural integrity and functionality of the lift and tilt mechanism 190 are not compromised, the mechanism may be shaped to fit round such other equipment.

The lower plates 150 are connected by a crossbar. The crossbar is of a relatively large diameter and corresponding high stiffness. High stiffness is desirable because the crossbar functions to prevent any rotation of the lower plates 150 about longitudinal axes 148A of the shafts 148, and to prevent the lower columns on the shafts from sliding forwards or backwards by different amounts. The crossbar, and its attachments to the lower plates 150, must thus be very rigid. Two additional crossbars are also provided between the two upper plates 156.

A lift actuator 162 extends between the crossbar of the lower plates 150 and the higher of the two crossbars between the upper plates 156. The lift actuator 162 is conventional, for example a hydraulic cylinder or an electric ball screw. In normal use, the lift actuator 162 is always under a load when a user 20 is sitting the chair 30. compression. A single-acting actuator may thus be sufficient. However, a double-acting actuator may be preferred to provide positively controlled lowering of the seat 34. Preferably, a lift damper 196 is provided and oriented generally parallel to the lift actuator 162.

On each side of the lift and tilt mechanism 190, a control arm 158 extends from a first bracket on the side rail of the mounting frame to a second bracket on the lower lift arm 152. In the embodiment illustrated, the second bracket is located approximately midway along the lower lift arm 152, and the control arm 158 is slightly shorter than half the length of the lower lift arm 152. The first bracket is near a forward end of the mounting frame side rail. When the lift and tilt mechanism 190 is fully lowered, the control arms 158 are approximately parallel to the side rails and are approximately aligned with the pivot where the lower lift arm 152 is connected to the lower plate 150.

A seat frame comprises two side rails 194. A tilt actuator 192 and preferably a tilt damper 198 extend from the lower crossbar connecting the upper plates 156 to the rear cross tube. The width between the two side rails 194 is adjustable, allowing a wide range of different seats to be attached without alteration to the lift and tilt mechanism 190 itself. Other elements of the wheelchair may also be attached to the side rails 194, including leg supports, arm rests, and the like (not shown).

In operation, to lift the seat 34, the user 20 operates an appropriate control device such as a switch, causing the lift actuator 162 to extend the linkage 140, moving the linkage from the first lowered position 142 to a raised position 144. The control arm 158 constrains movement of the linkage 140 such that the user's center of gravity e.g. is maintained in substantially the same longitudinal position relative to the wheelchair frame 12 during the process of extending the linkage 140. Controls for the lift and tilt actuators 162, 192 are timed or synchronized to prevent interference between the various components. Motion of the lift and tilt actuators 162, 192 is limited by stops. Position sensors may be provided to indicate to a controller (not shown) position of the actuators 162, 192 and/or components coupled to the actuators. Operational speed of each actuator 162, 192 is preferably controlled via conventional pulse modulation techniques.

Because the linkage 140 is constructed as a parallelogram and because the lower plates 150 are fixed against rotation, the upper plates 156 are lifted without rotating, so the seat 34 remains in the same untilted orientation as when the lift and tilt mechanism 190 was fully lowered. There is no change in the position of the tilt actuator 192. However, the tilt actuator 192 is in compression as soon as the seat lifts off end travel stoppers, and so it must be either activated or locked.

In order to tilt the seat 34, the seat 34 must be in a raised condition as the side rail rearward ends 194B are lowered by retraction of the tilt actuator 192.

The present invention may be embodied in other specific forms without departing from the spirit or essential attributes thereof and, accordingly, reference should be made to the appended claims, rather than to the foregoing specification, as indicating the scope of the invention. For example, it will be understood that the invention could be incorporated into wheelchairs having various types of seats, and various types of user controls. Also, it should be understood that the seat may include a recline mechanism, for permitting the backrest to pivot away from its upright position while the seat remains stationary. This backrest recline mechanism may be manually controlled or powered by means of actuators and/or linkage. The recline mechanism may also include structures that minimize shear by the seat back during operation. It is further contemplated that the leg supports may be manual or powered as desired. Other powered or manually controlled attachments may be included in the wheelchair structure or attached to the frame of the lift and tilt mechanism. Of course, any additional powered attachments will require modification of the existing controller to accommodate their operation or provision of a separate control mechanism.

Although the invention has been described and illustrated with respect to the exemplary embodiments thereof, it should be understood by those skilled in the art that the foregoing and various other changes, omissions and additions may be made therein and thereto, without parting from the spirit and scope of the present invention. Accordingly, reference should be made to the appended claims, rather than to the foregoing specification, as indicating the scope of the invention.

1. A wheelchair comprising:
a frame;
a plurality of wheels operatively coupled to the frame for rolling engagement with a supporting surface;
a chair including a backrest and a seat; and
at least a first seat lifting mechanism, coupled to the seat for raising and lowering the seat, including:
a rail member coupled to the frame and having a longitudinal axis extending generally parallel to the supporting surface;
a non-rotatable first member slidingly engaged with the rail member;
second and third members each pivotally coupled at a first end to the first member, and each pivotally coupled at a second end to a fourth member, wherein the first, second, third and fourth members form a closed linkage substantially defining a parallelogram; and
a fifth member having a first end rotatably coupled to the frame and having a second end rotatably coupled to one of the second and third members at a point intermediate the first and second ends;
a lift actuator operatively attached to at least one of the first through fourth members to control movement of the linkage between a first lift position and a second lift position;
wherein in the first lift position the seat is retracted toward the supporting surface and in the second lift position the seat is extended away from the supporting surface;
wherein as the lift actuator moves the lift mechanism between the first and second lift positions, the first member slides along the rail member; and
wherein the fifth member is positioned and dimensioned such that as the linkage moves between the first and second lift positions, the linkage is constrained by the fifth member such that the first member undergoes a displacement along the rail member sufficient to maintain the fourth member in a substantially constant longitudinal position relative to the frame.

2. The wheelchair of claim 1 further comprising a second lift mechanism, and the seat having a right-hand side and a left-hand side, wherein the first lift mechanism is coupled to the right-hand side and the second lift mechanism is coupled to the left-hand side.

3. The wheelchair of claim 1 wherein the lift actuator is a rotary actuator.

4. The wheelchair of claim 1 wherein the lift actuator is a linear actuator.

5. The wheelchair of claim 4 wherein the linear actuator is rotatably attached at a first end to the first member and rotatably attached at a second end to the fourth member and the linear actuator extends to move the linkage from the first lift position to the second lift position.

6. The wheelchair of claim 1 wherein the chair is fixedly coupled to the fourth member.

7. The wheelchair of claim 1 further comprising a lift damper operatively coupled to at least one of the members to resist motion of the linkage as the linkage moves between the second lift position and the first lift position.

8. The wheelchair of claim 1 wherein the first member includes a bearing operatively coupled to the rail member.

9. A wheelchair comprising:
a frame;
a plurality of wheels operatively coupled to the frame for rolling engagement with a supporting surface;
a chair including a backrest and a seat having a forward end and a rearward end, the chair having a first tilt position wherein the seat is substantially parallel with the supporting surface and a second tilt position wherein the seat is tilted relative to the supporting surface such that the forward end is higher relative to the supporting surface than the rearward end; and
a chair tilting mechanism including:
a rail member fixedly coupled to the frame and having a longitudinal axis extending generally parallel to the supporting surface;
a first member fixedly coupled to the seat and having a first end and a second end, wherein the second end is slidingly engaged with the rail member;
a second member having a first end rotatably coupled to the frame and a second end rotatably coupled to the first member at a point intermediate the first member first and second ends;
a linear tilt actuator having a first end rotatably coupled to the frame and having a second end rotatably coupled to the first end of the first member,
wherein the tilt actuator controls movement of the chair between the first tilt position and the second tilt position, and
wherein the second member is positioned and dimensioned such that as the chair is moved between the first and second tilt positions, the second end of the first member slides along the rail member and a center of gravity of a user occupying the chair is maintained in a substantially constant longitudinal position relative to the frame.

10. The wheelchair of claim 9, wherein the actuator extends to move the chair from the first tilt position to the second tilt position and retracts to move the chair from the second tilt position to the first tilt position.

11. The wheelchair of claim 9 further comprising a tilt damper operatively coupled to the seat to resist motion of the chair as the chair moves between the second tilt position and the first tilt position

12. A wheelchair comprising:
a frame;
a plurality of wheels operatively coupled to the frame for rolling engagement with a supporting surface;
a chair including a backrest and a seat having a first end and a second end;
a combined chair lift and tilt mechanism having:
at least a first chair lifting mechanism coupled to the chair for raising and lowering the chair, including:
a rail member coupled to the frame and having a longitudinal axis extending generally parallel to the supporting surface;
a non-rotatable first member slidingly engaged with the rail member;
second and third members each pivotally coupled at a first end to the first member, and each pivotally coupled at a second end to a fourth member, wherein the first, second, third and fourth members form a closed linkage substantially defining a parallelogram and wherein the fourth member is rotatably coupled to the seat proximate the seat first end; and
a fifth member having a first end rotatably coupled to the frame and having a second end rotatably coupled to one of the second and third members at a point intermediate the first and second ends;
a lift actuator operatively attached to at least one of the first through fourth members to control movement of the linkage between a first lift position and a second lift position;
wherein in the first lift position the seat is retracted toward the supporting surface and in the second lift position the seat is extended away from the supporting surface;
wherein as the lift actuator moves the lift mechanism between the first and second lift positions, the first member slides along the rail member; and
wherein the fifth member is positioned and dimensioned such that as the linkage moves between the first and second lift positions, the linkage is constrained by the fifth member such that the first member undergoes a displacement along the rail member sufficient to maintain the fourth member in a substantially constant longitudinal position relative to the frame, and
a tilt actuator operatively coupled to the seat, wherein the tilt actuator controls movement of the chair between a first tilt position and a second tilt position.

13. The wheelchair of claim 12 further comprising a second lift mechanism, and the seat having a right-hand side and a left-hand side, wherein the first lift mechanism is coupled to the right-hand side and the second lift mechanism is coupled to the left-hand side.

14. The wheelchair of claim 12 further comprising a lift damper operatively coupled to at least one of the members to resist motion of the linkage as the linkage moves between the second lift position and the first lift position.

15. The wheelchair of claim 12 further comprising a tilt damper operatively coupled to the seat to resist motion of the chair as the chair moves between the first tilt position and the second tilt position.
